(19) United States
(12) Patent Application Publication
(10) Pub. No.: US 2018/0363370 A1
(43) Pub. Date: Dec. 20, 2018

(54) Shade Winding/release Controller

(71) Applicant: Li-Ming Cheng, Kaohsiung (TW)

(72) Inventor: Li-Ming Cheng, Kaohsiung (TW)

(21) Appl. No.: 15/624,736

(22) Filed: Jun. 16, 2017

(51) Int. Cl. E06B 9/80; E06B 9/78; F16H 1/28; F16H 37/04

(52) U.S. Cl. CPC E06B 9/80; E06B 9/78; F16H 2001/2872; F16H 37/041; E06B 2009/785; F16H 1/28

(57) ABSTRACT

A shade winding/release controller includes a casing having a first locating cavity and a second locating cavity. A pulling wheel is rotatably mounted in the first locating cavity. A fixed toothed seat is fixed in the casing and includes a first inner toothed portion. A driving member is mounted in the fixed toothed seat and is connected to the pulling wheel. At least one transmission wheel is connected to and driven by the driving member. The at least one transmission wheel includes coaxially disposed first and second outer toothed portions having different specifications. The first outer toothed portion meshes with the first inner toothed portion of the fixed toothed seat. A shaft-coupling toothed seat is rotatably mounted in the second locating cavity. The shaft-coupling toothed seat includes a second toothed portion meshed with the outer toothed portion.

### BACKGROUND OF THE INVENTION

### 1. Field of the Invention

The present invention relates to a part of a window shade and, more particularly, to a shade winding/release controller for controlling a shade of a window shade system.

### 2. Description of the Related Art

Conventional window systems generally include a shade winding/release controller permitting a user to control the extent of winding or release of a shade by pulling a pulling member (such as a bead chain or a pull cord) on a side. Conventional shade winding/release controllers include a coil spring to maintain the shade in the desired winding/release extent for increasing the positioning effect of the shade. When the pulling member is used to control winding or release of the shade, two ends of the coil spring are pulled away from each other, such that a rotating shaft of the shade is not tightened, permitting controlled rotation of the rotating shaft. When the shade is directly pulled, the coil spring tightens the rotating shaft of the shade to avoid winding or release of the shade.

The conventional shade winding/release controllers assure that the winding/release extent of the shade can only be controlled by the pulling member to avoid a change in the extended length of the shade resulting from inadvertent pulling of the shade which requires to pull the pulling member again to return the shade to the original extended length. Thus, the conventional shade winding/release controllers increase the positioning effect of the shade and provide improved use convenience. An example of such conventional shade winding/release controllers is disclosed in U.S. Pat. No. 6,685,592 B2.

However, the elasticity of the coil springs in the conventional shade winding/release controller decrease after a period of time of use, leading to gradual reduction in the tightening effect of the rotating shafts of the shades. Replacement of the coil springs is required. Improvement is, thus, necessary.

### SUMMARY OF THE INVENTION

To solve the above problems, the present invention provides a shade winding/release controller utilizing a simple gear unit to achieve a reliable positioning effect of the shade. Furthermore, the gear unit can maintain accurate meshing even after long-term use. Thus, the shade winding/release controller according to the present invention is durable and almost without the need of maintenance and replacement of parts.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

A shade winding/release controller according the present invention includes a casing having a first locating cavity and a second locating cavity. A pulling wheel is rotatably mounted in the first locating cavity. A fixed toothed seat is fixed in the casing and includes a first inner toothed portion. A driving member is mounted in the fixed toothed seat and is connected to the pulling wheel. At least one transmission wheel is connected to and driven by the driving member. The transmission wheel includes a first outer toothed portion and a second outer toothed portion coaxial to the first outer toothed portion and having specifications different from specifications of the first outer toothed portion. The first outer toothed portion meshes with the first inner toothed portion of the fixed toothed seat. A shaft-coupling toothed seat is rotatably mounted in the second locating cavity. The shaft-coupling toothed seat includes a second toothed portion meshed with the outer toothed portion of the at least one transmission wheel.

By such an arrangement, the shade winding/release controller according to the present invention can use a simple gear unit to achieve the effect of reliably positioning the shade. Furthermore, the gear unit can maintain accurate meshing even after long-term use. In comparison with the conventional design using the coil springs suffering from gradual fatigue, the shade winding/release controller according to the present invention is more durable and almost without the need of maintenance and replacement of parts. Accordingly, the present invention achieves multiple effects including the positioning effect of the shade, prolong the service life of parts, and reducing the maintenance costs.

In an example, the number of teeth of the first outer toothed portion is different from the number of teeth of the second outer toothed portion, and the modulus of the first outer toothed portion is preferably equal to the modulus of the second outer toothed portion. The structure is simple and is easy to manufacture and assemble, reducing the manufacturing costs and increasing assembling convenience.

In an example, the number of teeth of the first outer toothed portion is larger than the number of teeth of the second outer toothed portion.

In an example, a spacing between a central axis of the second inner toothed portion and a central axis of the second outer toothed portion is substantially equal to a spacing between a central axis of the first inner toothed portion and a central axis of the first outer toothed portion. This assures the transmission wheel to more smoothly drive the shaft-coupling toothed seat to rotate.

In an example, plural transmission wheels are used to share the operational force to reduce the wear of the teeth. Thus, the plural transmission wheels, the fixed toothed seat, and the shaft-coupling toothed seat are more durable.

In an example, the fixed toothed seat includes a first opening and a second opening aligned with the first opening along a central axis of the first inner toothed portion. The fixed toothed seat includes a first chamber between the first inner toothed portion and the first opening. The fixed toothed seat further includes a second chamber between the first inner toothed portion and the second opening. This structure is simple, is easy to manufacture, and permits easy assembly of other components, reducing the manufacturing costs and increasing assembling convenience.

In an example, the driving member is mounted in the first chamber. The driving member includes an engaging portion and a shaft coupling portion respectively on two opposite faces thereof. The engaging portion extends out of the first opening of the fixed toothed seat and engages with the pulling wheel. The shaft coupling portion extends into the second chamber of the fixed toothed seat and is rotatably coupled to the at least one transmission wheel. The second inner toothed portion of the shaft-coupling toothed seat extends into the second chamber and meshes with the second outer toothed portion of the at least one transmission wheel. The structure of the shade winding/release controller is simpler and more easily to manufacture and assemble, reducing the manufacturing costs and increasing assembling convenience.

In another example, the driving member is mounted in the first chamber. The driving member includes an engaging portion and a central gear on two opposite faces thereof. The engaging portion extends out of the first opening of the fixed toothed seat and engages with the pulling wheel. The central gear is mounted to a center of the driving member. The central gear meshes with the first outer toothed portion of the at least one transmission wheel. Thus, when the shade winding/release controller operates, the transmission wheel simultaneously meshes with the central gear and the first inner toothed portion of the fixed toothed seat, such that force is uniformly imparted to the transmission wheel to reduce the wear. Thus, the transmission wheel, the fixed toothed seat, and the shaft-coupling toothed seat are more durable.

In a further example, the shaft-coupling toothed seat includes an axle on a central portion thereof. A rotational disc rotatably mounted to the axle. The rotational disc includes a surface facing the fixed toothed seat. At least one shaft coupling portion is disposed on the surface of the rotational disc. The number of the at least one shaft coupling portion is equal to the number of the at least one transmission wheel. The transmission wheel is rotatably mounted to the at least one shaft coupling portion. The structure is simple and is easy to manufacture and assemble, reducing the manufacturing costs and increasing assembling convenience.

The present invention will become clearer in light of the following detailed description of illustrative embodiments of this invention described in connection with the drawings.

### BRIEF DESCRIPTION OF THE DRAWINGS

FIG. 1 is a diagrammatic exploded, perspective view of a shade winding/release controller of a first embodiment according to the present invention.

FIG. 2 is a diagrammatic cross sectional view of the shade winding/release controller of the first embodiment after assembly.

FIG. 3 is a cross sectional view taken along section line A-A of FIG. 2.

FIG. 4 is a cross sectional view taken along section line B-B of FIG. 2.

FIG. 5 is a diagrammatic exploded, perspective view of a shade winding/release controller of a second embodiment according to the present invention.

FIG. 6 is a diagrammatic cross sectional view of the shade winding/release controller of the second embodiment after assembly.

FIG. 7 is a diagrammatic exploded, perspective view of a shade winding/release controller of a third embodiment according to the present invention.

FIG. 8 is a diagrammatic cross sectional view of the shade winding/release controller of the third embodiment after assembly.

### DETAILED DESCRIPTION OF THE INVENTION

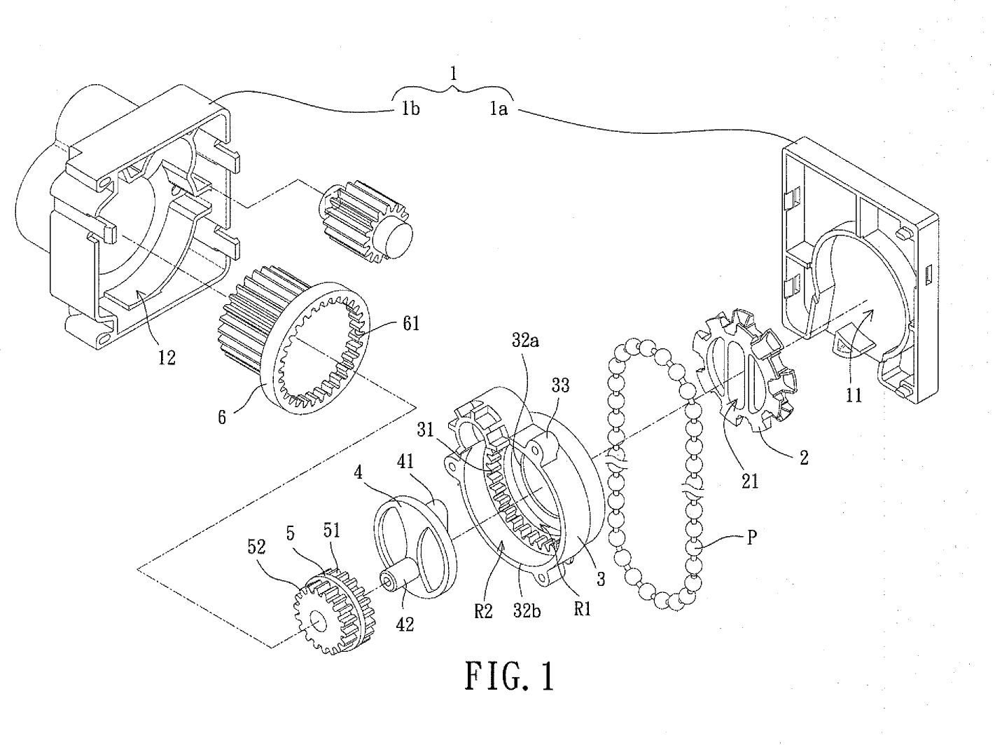

With reference to FIG. 1, a shade winding/release controller of a first embodiment according to the present invention includes a casing 1, a pulling wheel 2, a fixed toothed seat 3, a driving member 4, at least one transmission wheel 5, and a shaft-coupling toothed seat 6.

The casing 1 is used to assemble and position the above components and to provide functions of covering and protection. Furthermore, the casing 1 permits the whole shade winding/release controller to be conveniently assembled to an upper track of a window shade system, such that a user can use a pulling member P (such as a bead chain or a pull cord) to control the shade winding/release controller to thereby control the winding/release extent of a shade. Thus, the casing 1 can have various shapes according to the needs. In this embodiment, the casing 1 can, but not limited to, be split into a first casing 1a and a second casing 1b.

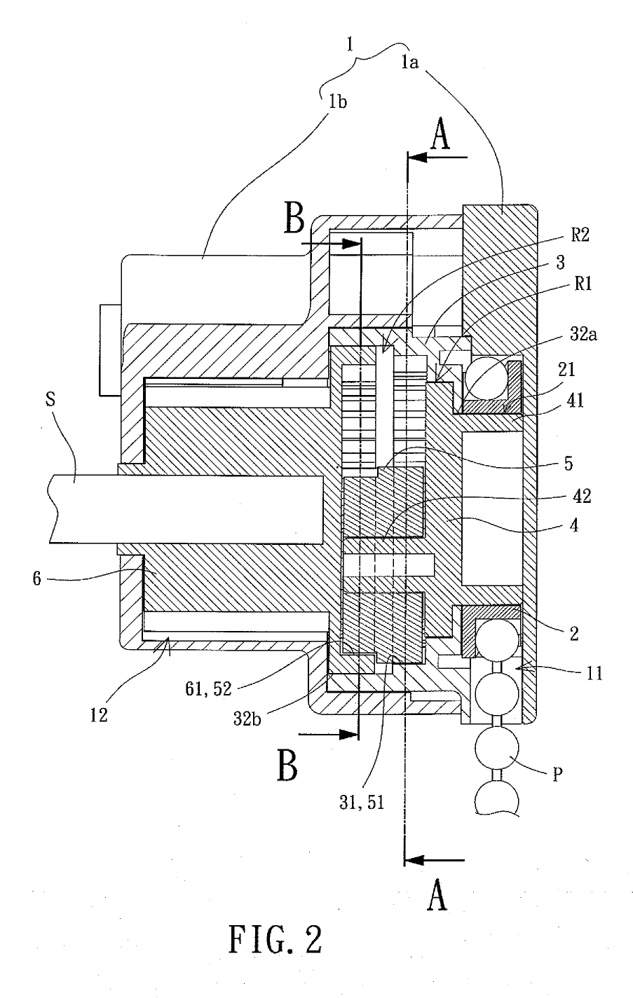

Specifically, with reference to FIGS. 1 and 2, the first casing 1a includes a first locating cavity 11 for receiving the pulling wheel 2 and for covering a portion of the pulling member P that is mounted around an outer periphery of the pulling wheel 2. The second casing 1b includes a second locating cavity 12 for receiving the shaft-coupling toothed seat 6 and for partial alignment and engagement of the fixed toothed seat 3.

The pulling wheel 2 is mounted in the first locating cavity 11 of the first casing 1a. The pulling member P is mounted around and positioned by the outer periphery of the pulling wheel 2. Thus, the pulling member P can be pulled to control the pulling wheel 2 to rotate in the forward direction to thereby control winding of the shade or to rotate in the reverse direction to thereby control extension of the shade. Furthermore, the pulling wheel 2 includes a non-circular through-hole 21 in a central portion thereof for coupling with the driving member 4.

The fixed toothed seat 3 includes a first inner toothed portion 31 therein. The fixed toothed seat 3 includes a first opening 32a and a second opening 32b aligned with the first opening 32a along a central axis of the first inner toothed portion 31. The first opening 32a is adjacent to the first casing 1a, and the second opening 32b is adjacent to the second casing 1b. A first chamber R1 is defined between the first inner toothed portion 31 and the first opening 32a of the fixed toothed seat 3 and receives the driving member 4. A second chamber R2 is defined between the first inner toothed portion 31 and the second opening 32b of the fixed toothed seat 3 and receives a front end of the shaft-coupling toothed seat 6. A plurality of fixing portions 33 is provided on an outer periphery of the fixed toothed seat 3 for fixing to the second casing 1b, such that the fixed toothed seat 3 is fixed in the casing 1 without rotation or movement.

The driving member 4 is mounted in the first chamber R1 of the fixed toothed seat 3. In this embodiment, the driving member 4 includes an engaging portion 41 and a shaft coupling portion 42 respectively on two opposite faces thereof. The engaging portion 41 extends out of the first opening 32a of the fixed toothed seat 3 and engages with the through-hole 21 of the pulling wheel 2. The shaft coupling portion 42 extends into the second chamber R2 of the fixed toothed seat 3 and is rotatably coupled to the transmission wheel 5. The shaft coupling portion 42 is disposed in a position eccentric to a central axis of the driving member 4. Thus, when the driving member 4 rotates about its central axis, the shaft coupling portion 42 moves in a circular path about the central axis of the driving member 4.

The transmission wheel 5 is connected to and driven by the driving member 4. In this embodiment, the transmission wheel 5 is rotatably mounted to the shaft coupling portion 42 of the driving member 4. First and second outer toothed portions 51 and 52 are fixed along a central axis of the transmission wheel 5 and can rotate synchronously. The first outer toothed portion 51 meshes with the first inner toothed portion 31 of the fixed toothed seat 3. The second outer toothed portion 52 meshes with the front end of the shaft-coupling toothed seat 6.

Note that the first outer toothed portion 51 is coaxial to the second outer toothed portion 52. The teeth of the first outer toothed portion 51 have the same specifications. The teeth of the second outer toothed portion 52 have the same specifications. Nevertheless, the specifications of each tooth of the first outer toothed portion 51 are different from the specifications of each tooth of the second outer toothed portion 52. For example, the first and second outer toothed portions 51 and 52 can have the same modulus but have different numbers of teeth. Thus, the diameters of the pitch circles of the first and second outer toothed portions 51 and 52 are different (the effect and principles will be explained hereinafter).

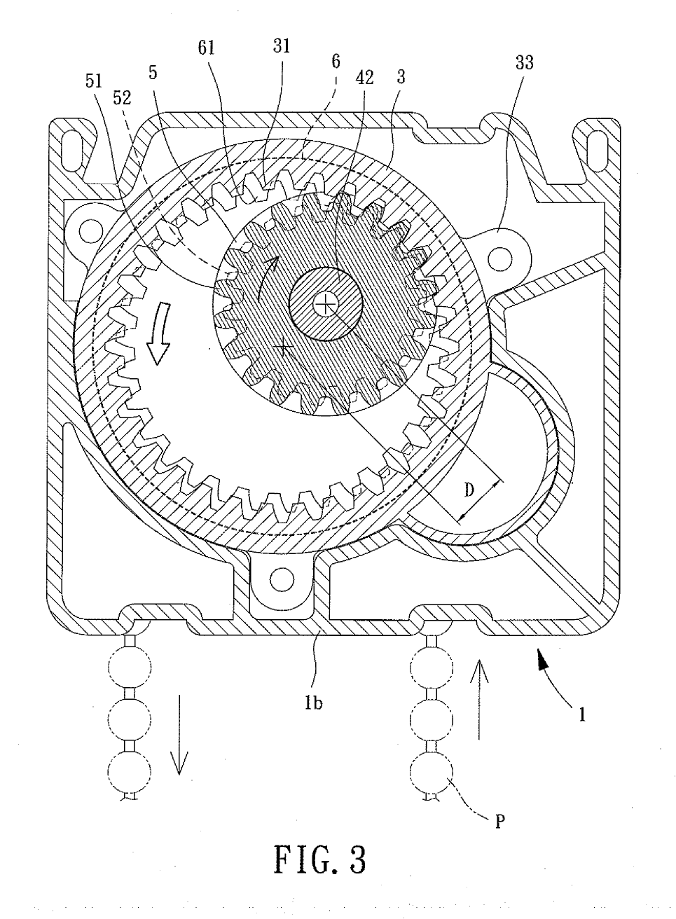

The shaft-coupling toothed seat 6 is rotatably mounted in the second locating cavity 12 of the second casing 1b. The front end of the shaft-coupling toothed seat 6 extends into the second chamber R2 of the fixed toothed seat 3 and includes a second inner toothed portion 61 meshed with the second outer toothed portion 52 of the transmission wheel 5. A spacing D (see FIG. 3) between a central axis of the second inner toothed portion 61 and a central axis of the second outer toothed portion 52 is substantially equal to a spacing D between the central axis of the first inner toothed portion 31 and the central axis of the first outer toothed portion 51. A rear end of the shaft-coupling toothed seat 6 can be directly or indirectly coupled to a rotating shaft S of the shade. Thus, when the shaft-coupling toothed seat 6 rotates, the rotating shaft S is driven to rotate to thereby wind or release the shade.

With reference to FIGS. 2 and 3, by the above structure, after the shade winding/release controller according to the present invention is mounted to the upper track of the window shade system, the pulling member P connected to the pulling wheel 2 generally dangles from a side of the window shade system for manual pulling by the user. The pulling member P can be pulled to control forward or reverse rotation of the pulling wheel 2 to thereby drive the rotating member 4 to rotate synchronously. At this time, the transmission wheel 5 is driven by the driving member 4 to rotate about the central axis of the driving member 4. Since the first outer toothed portion 51 of the transmission wheel 5 also meshes with the first inner toothed portion 31 of the fixed toothed seat 3, the transmission wheel 5 also rotates about the shaft coupling portion 42.

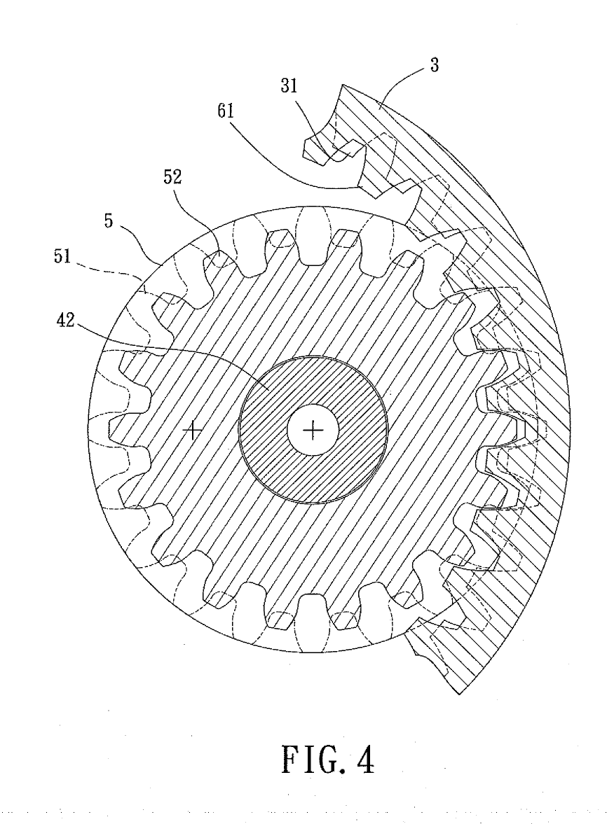

With reference to FIGS. 2 and 4, at this time, since the first and second outer toothed portions 51 and 52 have different numbers of teeth and rotate synchronously (and have the same angular speed), the difference in the number of teeth between the first and second outer toothed portions 51 and 52 results in a difference in the tangential speed, such that the second inner toothed portion 61 meshed with the second outer toothed portion 52 must rotate to keep up with the second outer toothed portion 52. Thus, the shaft-coupling toothed seat 6 rotates in the second locating cavity 12 of the second casing 1b to drive the rotating shaft S of the shade to rotate, thereby achieving the controlling effect of winding or releasing the shade. Particularly, in this embodiment, the number of teeth of the first outer toothed portion 51 can be selected to be larger than the number of teeth of the second outer toothed portion 52 to increase the torque outputted by the shaft-coupling toothed seat 6, thereby achieving a force saving effect.

With reference to FIG. 2, on the other hand, when the shade is pulled, the shade drives the rotating shaft S to rotate to thereby rotate the shaft-coupling toothed seat 6. Nevertheless, based on the above transmission principle, when it is desired to reversely use the shaft-coupling toothed seat 6 to drive the transmission wheel 5 to rotate, since the fixed toothed seat 3 is fixed in the casing 1 without rotation or movement, the first outer toothed portion 51 cannot drive the first inner toothed portion 31 meshed therewith, such that the whole transmission wheel 5 cannot rotate. Thus, the non-rotating transmission wheel 5 stops rotation of the shaft-coupling toothed seat 6 to thereby prevent rotation of the rotating shaft S of the shade.

Therefore, the shade winding/release controller according to the present invention can use a simple mechanical structure to assure that winding or release of the shade can only be controlled by the pulling member P and cannot be controlled by directly pulling the shade. Furthermore, the shade winding/release controller does not include elastic elements and, thus, has no problems of elastic fatigue. Thus, the shade winding/release controller according to the present invention is durable and almost without the need of maintenance and replacement of parts.

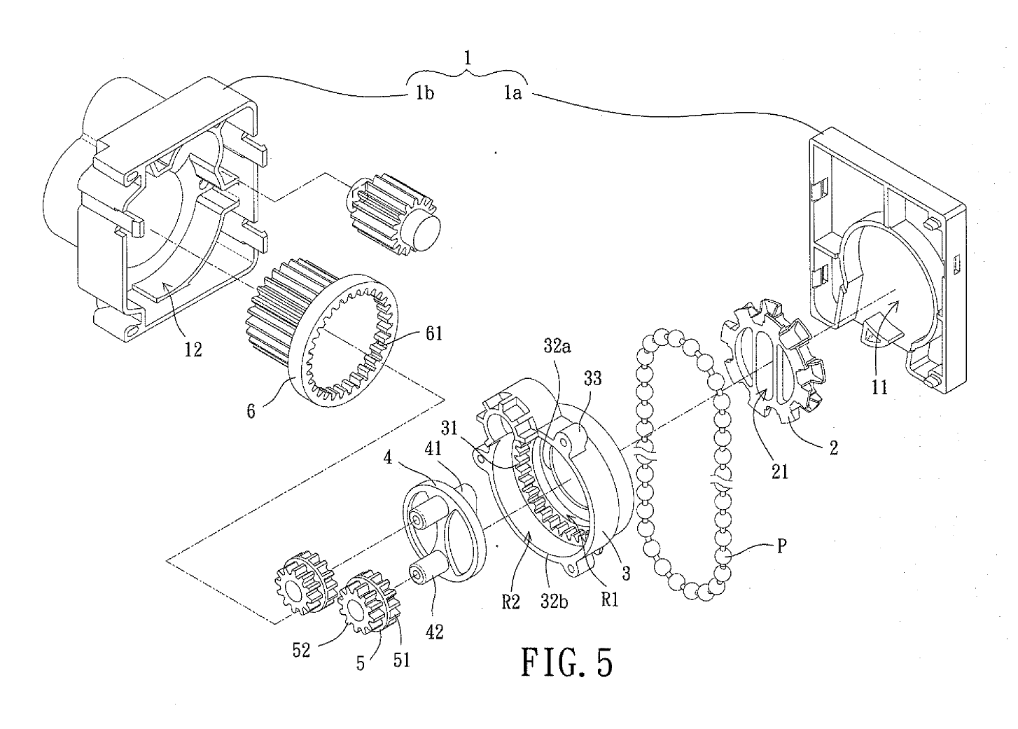

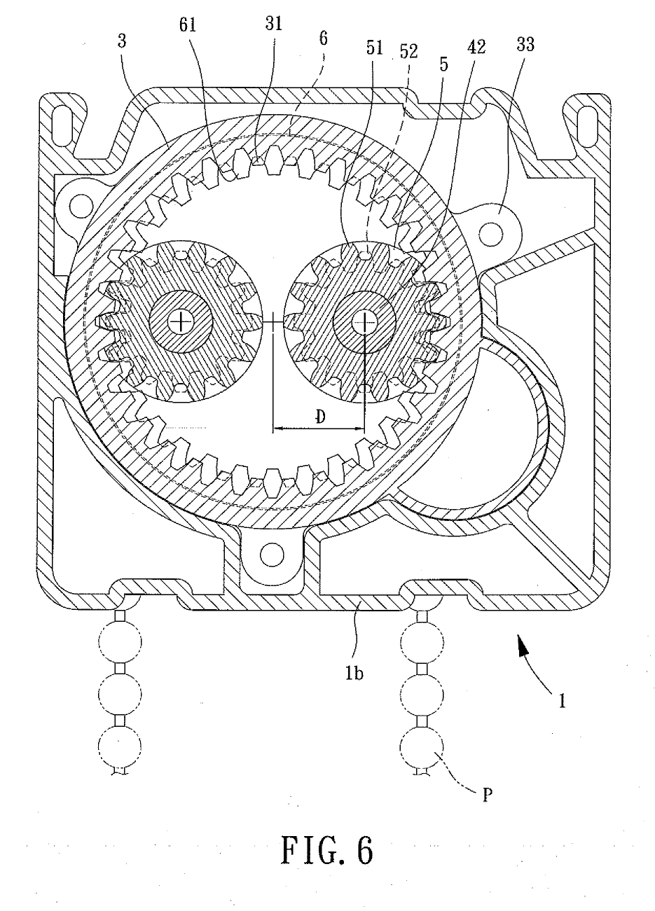

FIGS. 5 and 6 show a shade winding/release controller of a second embodiment according to the present invention which is substantially the same as the first embodiment. The main differences between the second embodiment and the first embodiment are that the driving member 4 of the second embodiment includes a plurality of shaft coupling portions 42 to connect with a corresponding number of transmission wheels 5. Although the second embodiment includes two transmission wheels, three or four transmission wheels 5 can be used. The present invention is not limited in this regard.

In operation of the shade winding/release controller of this embodiment, the plural transmission wheels 5 simultaneously mesh with the first inner toothed portion 31 of the fixed toothed seat 3 and the second inner toothed portion 61 of the shaft-coupling toothed seat 6, such that the plural transmission wheels 5 share the operational force to reduce the wear of the teeth. Thus, the plural transmission wheels 5, the fixed toothed seat 3, and the shaft-coupling toothed seat 6 are more durable.

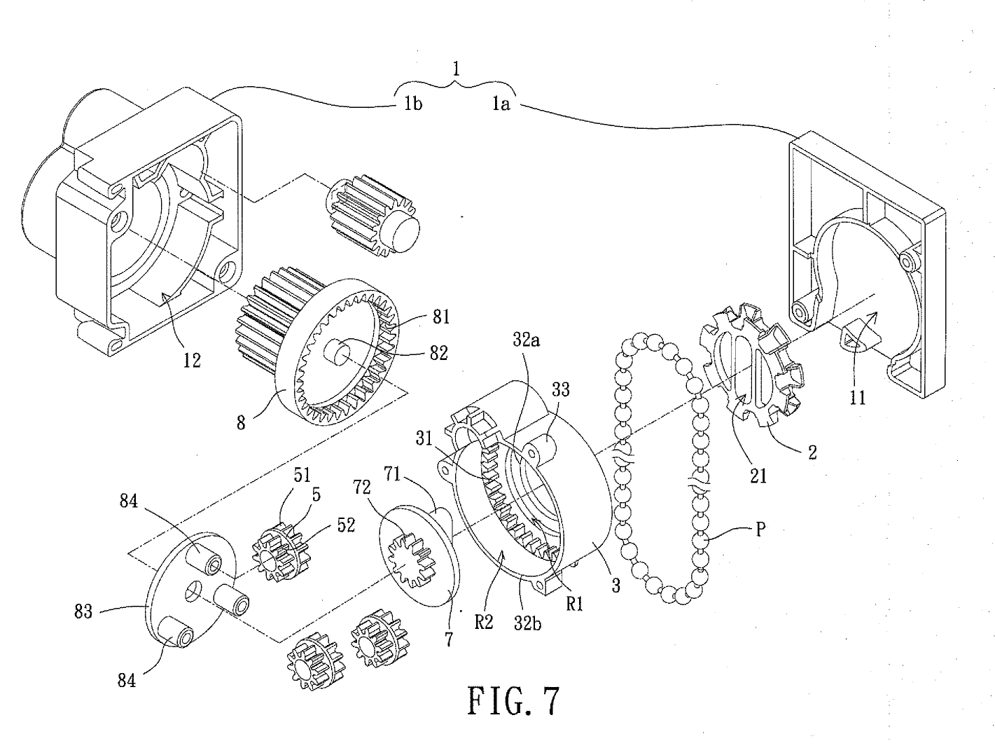

FIG. 7 shows a shade winding/release controller of a third embodiment according to the present invention which is substantially the same as the second embodiment. The main differences are the structures of the driving member 7 and the shaft-coupling toothed seat 8 of the third embodiment. Furthermore, the structure of the transmission wheels 5 of the third embodiment is identical to that of the previous embodiments. The third embodiment can include only one transmission wheel 5 or plural transmission wheels 5. The present invention is not limited in this regard.

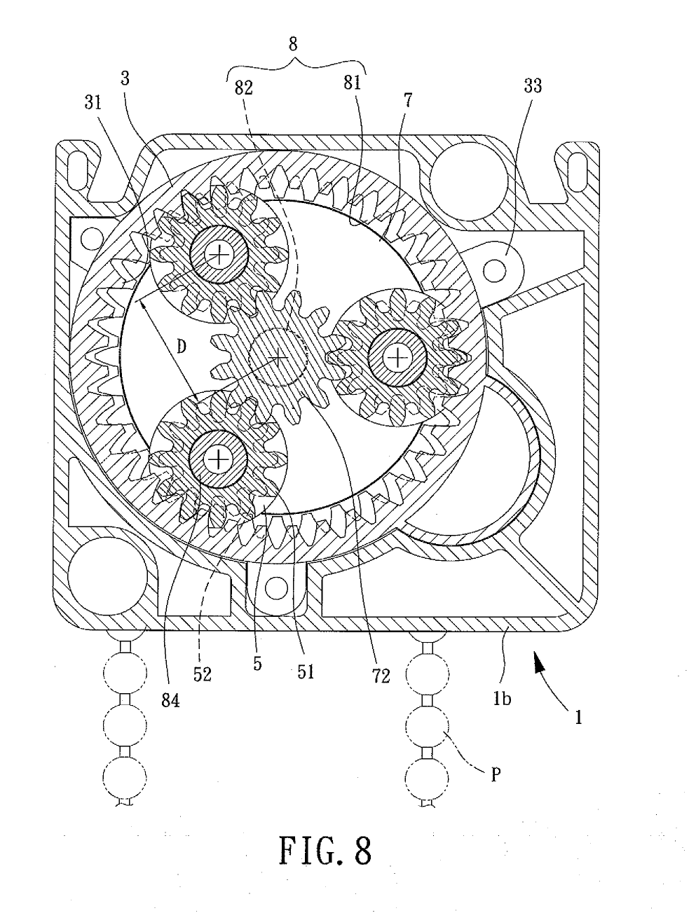

Specifically, with reference to FIGS. 7 and 8, the driving member 7 includes an engaging portion 71 and a central gear 72 on two opposite faces thereof. The engaging portion 71 extends out of the first opening 32a of the fixed toothed seat 3 and engages with the through-hole 21 of the pulling wheel 2. The central gear 72 is mounted to a center of the driving member 7 and is substantially aligned with the first inner toothed portion 31 of the fixed toothed seat 3 for meshing with the first outer toothed portion 51 of the at least one transmission wheel 5.

In addition to a second inner toothed portion 81 on the front end of the shaft-coupling toothed seat 8, an axle 82 is disposed on a central portion of the shaft-coupling toothed seat 8. A rotational disc 83 is rotatably mounted to the axle 82 and includes a surface facing the fixed toothed seat 3. Shaft coupling portions 84, whose number is equal to the number of the transmission wheels 5, are disposed on the surface of the rotational disc 83. The transmission wheels 5 are rotatably mounted to the shaft coupling portions 84. The shaft coupling portions 84 are eccentric to a central axis of the rotational disc 83, such that the shaft coupling portions 84 can move in a circular path about the central axis of the disc 83.

By the foregoing structure, when the user pulls the pulling member P to control the pulling wheel 2 to rotate in the forward or reverse direction, the driving member 7 is driven to rotate synchronously. The central gear 72 rotates the transmission wheels 5 meshed therewith. The transmission wheels 5 rotate along the first inner toothed portion 31 of the fixed toothed seat 3. At this time, the second outer toothed portions 52 of the rotating transmission wheels 5 drive the second inner toothed portion 81 meshed therewith, such that the shaft-coupling toothed seat 8 rotates in the second locating cavity 12 of the second casing 1b. Thus, the rotating shaft S of the shade is driven to rotate to control winding or release of the shade.

On the other hand, when the shade is pulled, the shade drives the rotating shaft S to rotate to thereby rotate the shaft-coupling toothed seat 8. Nevertheless, based on the above transmission principle, when it is desired to reversely use the shaft-coupling toothed seat 8 to drive the transmission wheels 5 to rotate, since the fixed toothed seat 3 is fixed in the casing 1 without rotation or movement, the first outer toothed portions 51 cannot drive the first inner toothed portion 31 meshed therewith, such that all of the transmission wheels 5 cannot rotate. Thus, the non-rotating transmission wheels 5 stop rotation of the shaft-coupling toothed seat 8 to thereby prevent rotation of the rotating shaft S of the shade.

Therefore, the shade winding/release controller of the third embodiment according to the present invention also can use a simple mechanical structure to assure that winding or release of the shade can only be controlled by the pulling member P and cannot be controlled by directly pulling the shade. Furthermore, the driving member 7 of the shade winding/release controller of the third embodiment includes the central gear 72, such that when the shade winding/release controller is operated, the transmission wheels 5 can simultaneously mesh with the central gear 72 and the first inner toothed portion 31 of the fixed toothed seat 3. Thus, the forces imparted to the transmission wheels 5 are more uniform to reduce the wear of the teeth, making the transmission wheels 5 and the fixed toothed seat 3 more durable. Particularly, in the case of plural transmission wheels 5 are used, the plural transmission wheels 5 share the operating force to more significantly prolong the service life. Furthermore, in comparison with the first and second embodiments, the third embodiment uses the central gear 72 of the driving member 7 as the driving member and, thus, obtains a better reduction ratio, obtaining a better force saving effect.

Note that although the first outer toothed portion 51 and the second outer toothed portion 52 of the transmission wheel 5 in each embodiment according to the present invention are different in the number of teeth, when the first and second outer toothed portions 51 and 52 have the same number of teeth but have different moduli, the same effect of preventing reverse rotation for reliably positioning the shade can be achieved. Therefore, “different specifications of teeth” are not limited to “different number of teeth”. All provisions using “different specifications of teeth” to achieve the effect of “preventing reverse rotation for reliably positioning the shade” are within the scope of the invention, which can be appreciated by one having ordinary skill in the art.

In view of the foregoing, the shade winding/release controller according to the present invention can use a simple gear unit to achieve the effect of reliably positioning the shade. Furthermore, the gear unit can maintain accurate meshing even after long-term use. In comparison with the conventional design using the coil springs suffering from gradual fatigue, the shade winding/release controller according to the present invention is more durable and almost without the need of maintenance and replacement of parts. Accordingly, the present invention achieves multiple effects including the positioning effect of the shade, prolong the service life of parts, and reducing the maintenance costs.

What is claimed is:

1. A shade winding/release controller comprising:
a casing including a first locating cavity and a second locating cavity;
a pulling wheel rotatably mounted in the first locating cavity;
a fixed toothed seat fixed in the casing and including a first inner toothed portion;
a driving member mounted in the fixed toothed seat and connected to the pulling wheel;
at least one transmission wheel connected to and driven by the driving member, with the at least one transmission wheel including a first outer toothed portion and a second outer toothed portion coaxial to the first outer toothed portion and having specifications different from specifications of the first outer toothed portion, and with the first outer toothed portion meshed with the first inner toothed portion of the fixed toothed seat; and
a shaft-coupling toothed seat rotatably mounted in the second locating cavity, with the shaft-coupling toothed seat including a second inner toothed portion meshed with the second outer toothed portion of the at least one transmission wheel.

2. The shade winding/release controller as claimed in claim 1, wherein a number of teeth of the first outer toothed portion is different from a number of teeth of the second outer toothed portion.

3. The shade winding/release controller as claimed in claim 2, wherein the first outer toothed portion has a modulus equal to a modulus of the second outer toothed portion.

4. The shade winding/release controller as claimed in claim 2, wherein the number of teeth of the first outer toothed portion is larger than the number of teeth of the second outer toothed portion.

5. The shade winding/release controller as claimed in claim 1, wherein a spacing between a central axis of the second inner toothed portion and a central axis of the second outer toothed portion is equal to a spacing between a central axis of the first inner toothed portion and a central axis of the first outer toothed portion.

6. The shade winding/release controller as claimed in claim 1, wherein the at least one transmission wheel includes a plurality of transmission wheels.

7. The shade winding/release controller as claimed in claim 1, with the fixed toothed seat including a first opening and a second opening aligned with the first opening along a central axis of the first inner toothed portion, with the fixed toothed seat including a first chamber between the first inner toothed portion and the first opening, and with the fixed toothed seat further including a second chamber between the first inner toothed portion and the second opening.

8. The shade winding/release controller as claimed in claim 7, with the driving member mounted in the first chamber, with the driving member including an engaging portion and a shaft coupling portion respectively on two opposite faces thereof, with the engaging portion extending out of the first opening of the fixed toothed seat and engaged with the pulling wheel, with the shaft coupling portion extending into the second chamber of the fixed toothed seat and rotatably coupled to the at least one transmission wheel, with the second inner toothed portion of the shaft-coupling toothed seat extending into the second chamber and meshed with the second outer toothed portion of the at least one transmission wheel.

9. The shade winding/release controller as claimed in claim 7, with the driving member mounted in the first chamber, with the driving member including an engaging portion and a central gear on two opposite faces thereof, with the engaging portion extending out of the first opening of the fixed toothed seat and engaged with the pulling wheel, with the central gear mounted to a center of the driving member, and with the central gear meshed with the first outer toothed portion of the at least one transmission wheel.

10. The shade winding/release controller as claimed in claim 9, with the shaft-coupling toothed seat including an axle on a central portion thereof, with a rotational disc rotatably mounted to the axle, with the rotational disc including a surface facing the fixed toothed seat, with at least one shaft coupling portion disposed on the surface of the rotational disc, with a number of the at least one shaft coupling portion being equal to a number of the at least one transmission wheel, and with the at least one transmission wheel rotatably mounted to the at least one shaft coupling portion.
